(19) United States
(12) Patent Application Publication
(10) Pub. No.: US 2014/0101462 A1
(43) Pub. Date: Apr. 10, 2014

(54) ENERGY-EFFICIENT UNINTERRUPTIBLE ELECTRICAL DISTRIBUTION SYSTEMS AND METHODS

(71) Applicant: Milan Ilic, San Jose, CA (US)

(72) Inventors: Jeff Rose, Los Gatos, CA (US); Milan Ilic, San Jose, CA (US)

(73) Assignee: INERTECH IP LLC, Danbury, CT (US)

(21) Appl. No.: 13/885,525

(22) PCT Filed: Nov. 15, 2011
(86) PCT No.: PCT/US11/60874

§ 371 Date: Aug. 6, 2013

Related U.S. Application Data
(60) Provisional application No. 61/413,766, filed on Nov. 15, 2010.

(51) Int. Cl. G06F 1/26

(52) U.S. Cl. CPC G06F 1/263
USPC 713/300

(57) ABSTRACT

A power distribution system for data center systems (and corresponding method) feeds DC power directly to a first AC-DC power supply of a computer system in the data center system and feeds AC power to a second AC-DC power supply of the computer system to efficiently and reliably provide an uninterruptible supply of power to the computer system. The power distribution system includes an energy storage unit for supplying the DC power, a charger for charging the energy storage unit, and an inverter through which the energy storage unit provides energy to an electrical substation of an electrical grid. The charger is configured to receive energy from a renewable energy source and the electrical substation. The inverter may also be configured to receive renewable energy from the renewable energy source and supply that energy to the electrical substation. An uninterruptible power supply may be coupled between the electrical substation and the AC power feed. The power distribution system further includes a monitor for monitoring the flow of current to and/or from the electrical substation, a communications interface for receiving messages or requests from a utility company associated with the electrical substation, and a controller for controlling the components of the power distribution system based on requests from the utility company and the information gathered by the monitor.

### CROSS-REFERENCE TO RELATED APPLICATIONS

This application claims priority to U.S. Provisional Patent Application No. 61/413,766 entitled ENERGY-EFFICIENT UNINTERRUPTIBLE ELECTRICAL DISTRIBUTION SYSTEMS AND METHODS, which was filed on Nov. 15, 2010.

### BACKGROUND

1. Technical Field

The present disclosure is directed to electrical distribution systems and methods for data centers and, in particular, energy-efficient uninterruptible electrical distribution systems and methods for data centers.

2. Background of Related Art

Many computer and communications systems, such as the computer systems in data centers, require continuous high-quality electrical power. Data centers often include many different computer systems, which can have thousands of electrical circuits distributing power among interrelated electrical devices, including servers. A power failure or even disturbance in just one of these circuits can disable the entire data center and can cause hours of lost time while computer systems are restored and data is recovered.

To protect against power failures or disturbances, power protection schemes have been developed for providing an uninterruptible and redundant source of power to computer systems in a data center. The general categories of modern uninterruptible power systems are on-line, line-interactive, or standby.

FIG. 1 illustrates an online system (also referred to as a double conversion system). The most common power protection scheme for a data center 110 uses uninterruptible power supplies (UPSs) 116 having an alternating current AC-DC converter 113, a DC-AC inverter 115, and a backup battery 122. The UPSs 116 provide AC power to one or more AC-DC power supplies 132a, 132b of one or more servers 130. When a UPS 116 senses a power failure, such as when a substation 105 fails to supply electrical power to the data center 110, the backup batteries 122 supply power to the servers 130 for a short period until either the power failure is resolved or a backup generator (e.g., a genset) begins to generate power for the data center 110.

The basic configuration of an online UPS is generally the same as for a standby or a line-interactive UPS. However, the online UPS generally is more expensive due to the inclusion of a large AC-to-DC battery charger/rectifier in which the rectifier and inverter are designed to run continuously with improved cooling systems. In a double conversion UPS, the rectifier directly drives the inverter, even when powered from normal AC, hence the term double conversion.

While the UPSs 116 can provide continuous electrical power to computer systems, they are inefficient and costly to operate because of the many conversions between AC and DC. Many companies have investigated a variety of backup power techniques in an attempt to minimize losses and increase efficiency. One technique involves connecting backup batteries to the output of the AC-DC power supplies 132a, 132b in each individual server 132. Another technique involves reconfiguring the servers 130 with a DC-DC converter and feeding 48 VDC to the DC-DC converter. These techniques, however, have proven to be just as inefficient and costly as conventional UPSs 116.

As illustrated in FIG. 1, a typical UPS 116 receives AC power from an electrical substation 105, converts that AC power to DC power to charge the backup battery 122, converts the DC power back to AC power, and provides that AC power to the servers 130 and other critical electrical systems and electronics of the data center 110. The AC-DC power supplies 132a, 132b of the servers 130, in turn, convert the AC power to DC power. Finally, other power circuitry of the servers 130 may convert the DC power to a level or levels appropriate for the electronic circuitry within the servers 130.

The main advantage of the online UPS is the ability to provide an electrical firewall between the incoming utility power and sensitive electronic equipment. The online UPS allows control of output voltage and frequency regardless of input voltage and frequency. The main disadvantages are higher system cost and lower efficiency due to double power conversion.

As a result of these many power conversions in the UPSs 116 and servers 130, a significant amount of electrical power is lost, heat is generated, and even more electrical power is needed to dissipate the generated heat.

### SUMMARY

The electrical distribution systems and methods of the present disclosure efficiently provide an uninterruptible supply of power to computer systems of a data center by feeding DC power from an energy storage unit to an AC-DC power supply of the computer system if the AC power from an external power source is insufficient to power the computer systems of the data center. AC-DC server switched-mode power supplies (SMPS) according to the present disclosure provide the capability of receiving voltages such as, for example, 325 V DC (230 V AC×√2) directly since the first action is to rectify the incoming voltage to DC. Although unbalanced heating in the input rectifier stage occurs with the full load passing through only half of the input voltage, the unbalanced heating is not a significant problem.

According to one aspect, the present disclosure features a data center system that includes a DC energy storage unit and at least one computer system. The at least one computer system includes at least a first AC-to-DC power converter directly coupled to the DC energy storage unit and a second AC-to-DC power converter coupled to an external AC power source. In some embodiments, the data center system further includes an uninterruptible power supply coupled between the external AC power source and the second AC-to-DC power converter of the at least one computer system.

The data center system may also include a charger coupled between the external AC power source and the DC energy storage unit. The charger is configured to charge the DC energy storage unit.

In some embodiments, the data center system further includes a controller configured to control the electrical energy provided by the DC energy storage unit. The DC energy storage unit may include a plurality of batteries and a plurality of switches controlled by the controller and configured to connect the plurality of batteries in series and/or parallel connections to cause the DC energy storage unit to provide a desired amount of DC voltage to the first AC-to-DC, or to the DC-DC power converter. For example, the controller may cause the plurality of switches to connect at least two batteries of the plurality of batteries in parallel so that the DC energy storage unit can provide a desired amount of DC voltage that is lower than a maximum DC voltage of the DC energy storage unit.

The data center system may further include an inverter coupled between the external AC power source and the DC energy storage unit. The inverter converts DC power from the DC energy storage unit into AC power and provides the AC power to the external AC power source. The data center system may further include a monitor coupled to the external AC power source that senses and calculates the net electrical energy flowing to or from the data center system.

In some embodiments, the data center system further includes a renewable energy source coupled to the DC energy storage unit to charge the DC energy source or to supply power directly to servers in the data center system. The renewable energy source may include a solar power source, a wind power source, a hydropower source, a fuel cell source, a geothermal power source, a tidal power source, or any combination of two or more of these power sources.

In other embodiments, the DC energy storage unit may supply a high DC voltage to the first AC-to-DC power converter to minimize the heating of portions of the data center system. The high DC voltage may be about 230 Volts or greater.

The present disclosure, in another aspect, features a method of providing an uninterruptible supply of power to a computer system. The method includes storing energy in an energy storage unit, supplying AC power to a first AC-to-DC power converter of the computer system, and supplying DC power from the energy storage unit to a second AC-to-DC power converter of the computer system if the AC power is insufficient to power the computer system. Supplying AC power may include supplying AC power from an uninterruptible power supply.

In some embodiments, the method further includes feeding energy from the energy storage unit to an electrical substation via an inverter. In other embodiments, the method further includes feeding energy from an electrical substation to the energy storage unit via a charger. In some embodiments, the charger function and the inverter function can be combined in a single energy storage unit. In yet other embodiments, the method includes receiving a request from an external computer system associated with an electrical substation (a) to provide a desired amount of energy from the energy storage unit to the electrical substation or (b) to receive a desired amount of energy from the electrical substation; and, in response to receiving the request, receiving energy from or providing energy to the electrical substation in an amount equal to or less than the desired amount of energy.

The present disclosure, in yet another aspect, features a modular data center. The modular data center includes a plurality of data pods having a DC energy storage unit and at least one computer system. The at least one computer system has at least one AC-to-DC power converter directly coupled to the DC energy storage unit. The modular data center also includes a DC power bus coupled to the DC energy storage units of the plurality of data pods. In some embodiments, each data pod includes a DC input and a DC output. The DC input is coupled to a diode to prevent the flow of current out of the DC input and the DC output is coupled to a second diode to prevent the flow of current into the DC output.

### BRIEF DESCRIPTION OF THE DRAWINGS

Various embodiments of the present disclosure are described herein with reference to the drawings wherein:

FIG. 1 is a block diagram of a data center system including a plurality of UPSs powering a plurality of servers according to the prior art;

FIG. 2 is a block diagram of a data pod according to embodiments of the present disclosure;

FIG. 3A is a block diagram of a data center system that includes only AC-DC power supplies according to embodiments of the present disclosure;

FIG. 3B is a block diagram of a data center system that includes DC-DC power supplies in addition to AC-DC power supplies according to embodiments of the present disclosure;

FIGS. 4A and 4B are block diagrams of servers illustrating the supply of power to the server electronics through the AC-DC power supplies according to embodiments of the present disclosure;

FIG. 4C is a block diagram of a server illustrating the supply of power to the server electronics of FIG. 3B through the DC-DC power supplies according to embodiments of the present disclosure;

FIGS. 5A-5C are circuit block diagrams of energy storage units according to embodiments of the present disclosure;

FIG. 6 is a block diagram of a data pod farm according to an embodiment of the present disclosure; and

FIG. 7 is a flow diagram of a method of providing an uninterruptible supply of power to a computer system according to some embodiments of the present disclosure.

### DETAILED DESCRIPTION

Embodiments of the presently disclosed energy-efficient uninterruptible electrical distribution systems and methods will now be described in detail with reference to the drawings, in which like reference numerals designate identical or corresponding elements in each of the several views.

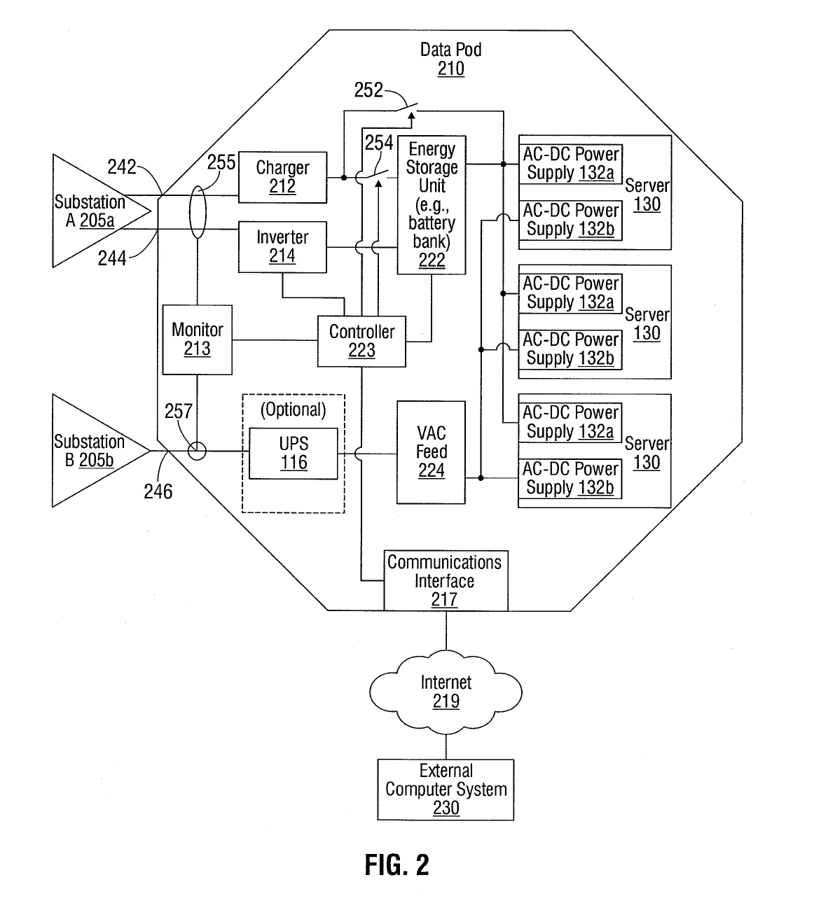

FIG. 2 is a block diagram of a data pod 210, which may be used in a modular data center solution, according to an embodiment of the present disclosure. The data pod 210 includes an energy storage unit 222 (e.g., a bank of batteries) for supplying DC power directly to a first AC-DC power supply 132a of a plurality of computer systems, e.g., servers 130, housed in the data pod 210. The AC-DC power supply 132 incorporates appropriate electrical components, such as rectifiers, that are configured to convert AC power to DC power.

The advantage of this embodiment over prior art power distribution systems as described above is that there are fewer conversions between AC power and DC power. Consequently, embodiments of the present disclosure can more efficiently provide an uninterruptible supply of power to the computer systems and other critical electrical systems and electronics of a data center. In addition, existing data centers can be quickly and easily retrofitted with appropriate components to conform to embodiments of the present disclosure.

The energy storage unit 222 may receive and supply a sufficiently high voltage to increase the efficiency of the power distribution system of FIG. 2. The energy storage unit 222 may include a plurality of batteries incorporating lithium-ion or lead-acid technology or other suitable battery technology. Alternatively or in addition to batteries, the energy storage unit 222 may include a plurality of ultracapacitors (also known as supercapacitors) or flywheels. The energy storage unit 222 may also be configured to start a backup generator (not shown).

The data pod 210 may optionally include a UPS 116, which feeds AC power through a VAC feed 224 (e.g., a bus) to a second AC-DC power supply 132b of the servers 130. The UPS 116 increases the reliability of the data pod's 210 power distribution system by, for example, providing backup power in case the energy storage unit 222 fails to provide backup power to the servers 130 during a power failure. Indeed, adding the UPS 116 increases the reliability of the data pod's 210 power distribution system from Tiers I and II to Tiers III and IV. Thus, embodiments of the data pod 210 that incorporate both an energy storage unit 222 and a UPS 116 provide a high level of reliability, efficiency, flexibility, and redundancy in comparison to conventional data centers that incorporate only a single UPS 116.

A power distribution system that incorporates an energy storage unit 222 and a UPS 116 has functionality similar to a conventional UPS, but has fewer losses and an added level of reliability. In the best case scenario, if the energy storage unit 222 supplies a high voltage (e.g., about 320 to about 325 Volts DC) to the servers 130 during a power outage, then the losses in the power distribution system can approach 0%. This is because a high-voltage DC power signal has a small current component, which translates into low losses and high efficiencies. In contrast, a conventional UPS would generate losses of about 3% to about 4%. These losses are generated at least in part by the electrical components in the UPS 116 that transform the DC power back to AC power.

As described above, in conventional servers, the AC-DC power supplies 132a, 132b both receive AC power from an AC power source (e.g., a UPS 116) and equally supply power to the server electronics. The dual AC-DC power supplies 132a, 132b in each server 130 provide redundancy and thus increased reliability. In contrast, the first AC-DC power supply 132a according to embodiments of the present disclosure is fed DC power from a DC power source (e.g., the energy storage unit 222) and a second AC-DC power supply 132b is fed AC power from an AC power source.

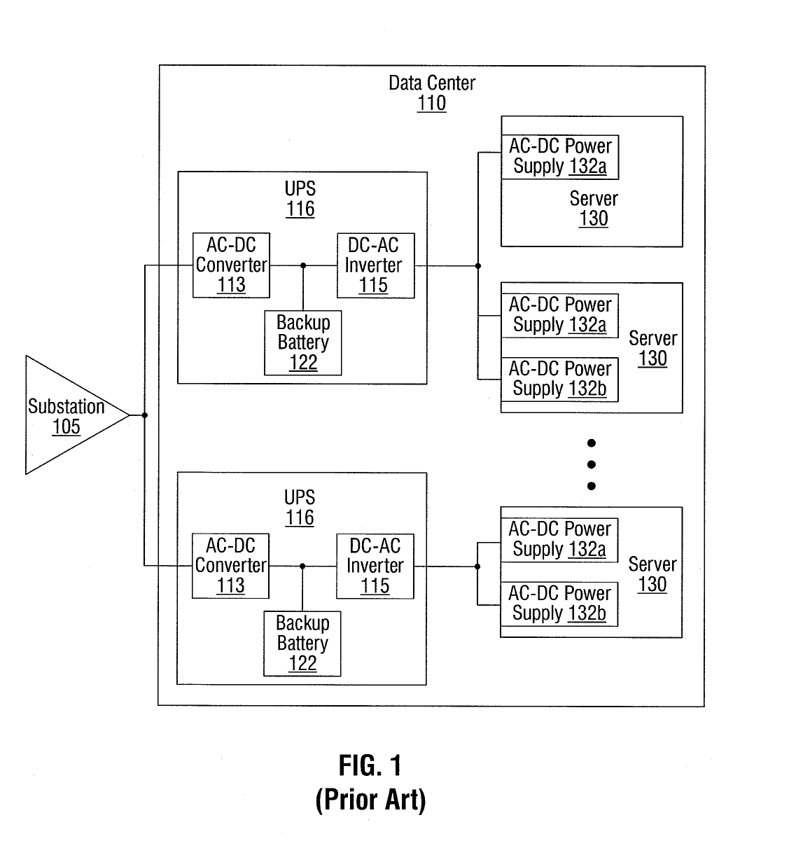

During normal operation, the external AC power source (e.g., first electrical substation 205a and/or second electrical substation 205b) together with the second AC-DC power supply 132b supply all the power to the server electronics while the first AC-DC power supply 132a is nonoperational and disconnected from the energy storage unit 222. If, however, the external AC power source cannot provide a sufficient amount of AC power to the first AC-DC power supply 132a to power the server electronics, then the energy storage unit 222 supplies DC power to the first AC-DC power supply 132a. In some embodiments, the backup battery of the UPS 116 (FIG. 1) may also supply AC power through the VAC feed 224 (e.g., a 400 VAC feed) to the second AC-DC power supply 132b to supplement the backup power provided by the energy storage unit 222. In some embodiments, the energy storage unit 222 and the first AC-DC power supply 132a are configured to supplement the power provided by the external AC power source in the case where the external AC power source can only provide a portion of the power required to operate the servers 130.

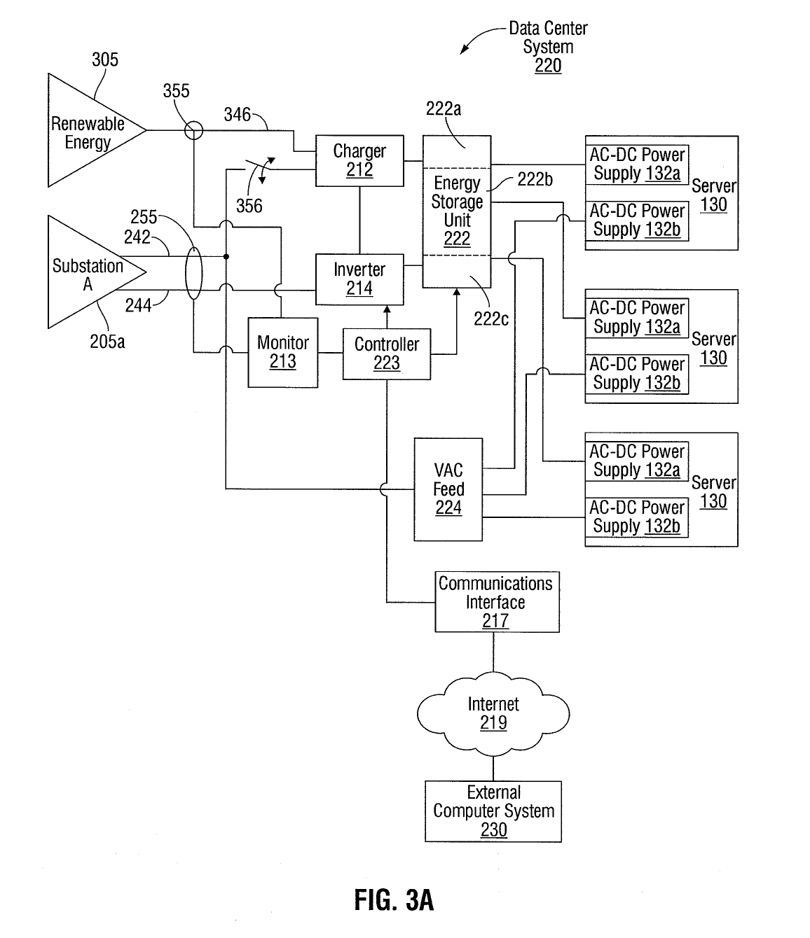

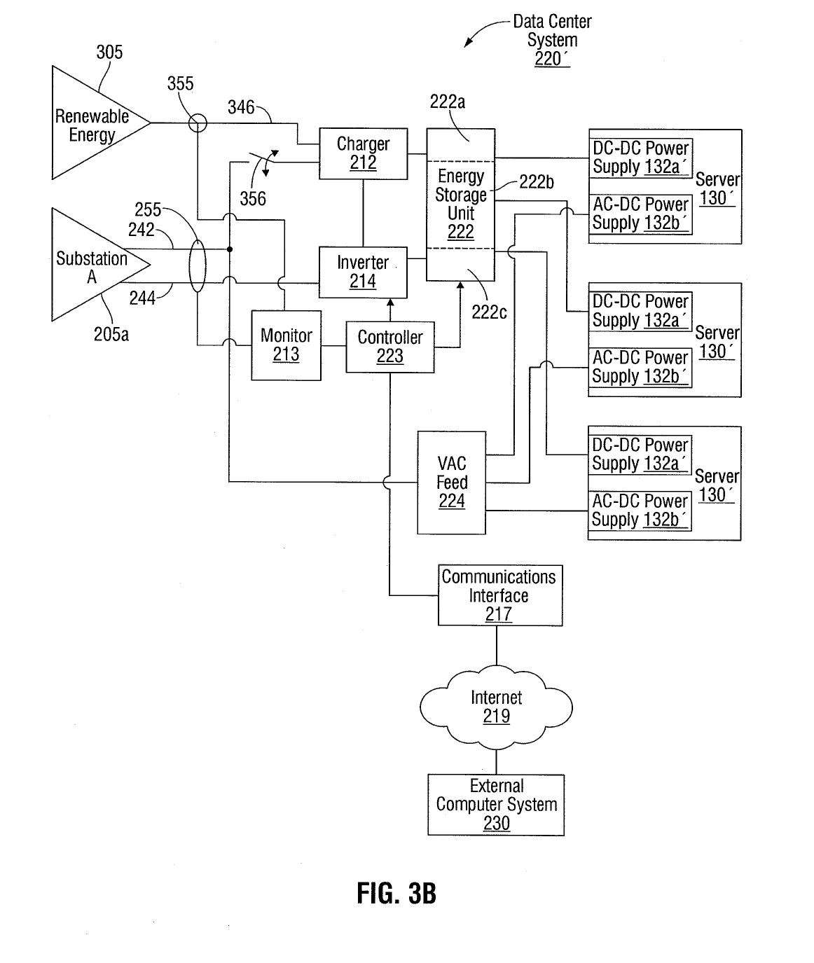

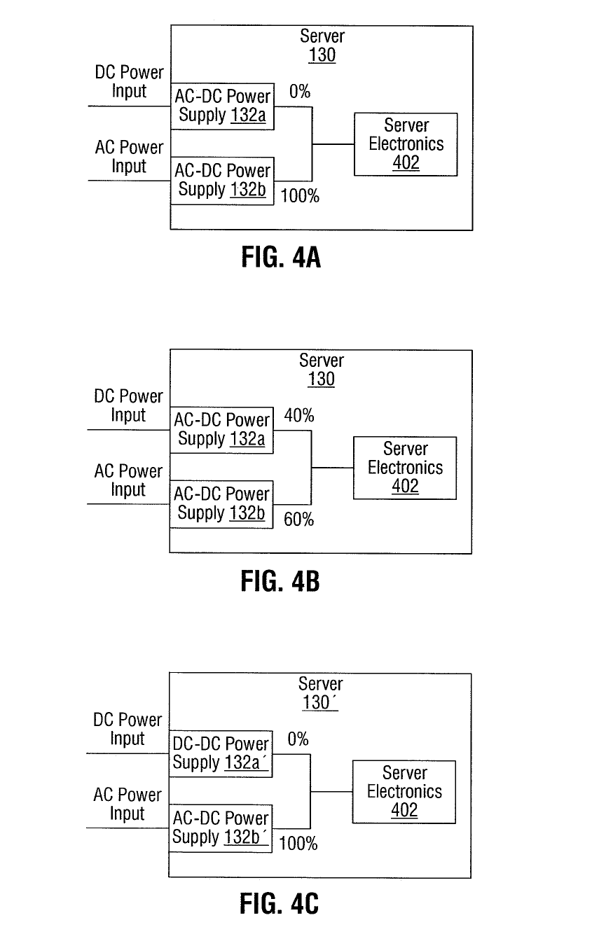

FIG. 3A illustrates a data center system that includes only AC-DC power supplies according to embodiments of the present disclosure. FIG. 3B illustrates a data center system that includes DC-DC power supplies in addition to AC-DC power supplies according to embodiments of the present disclosure. The data center systems of FIGS. 3A and 3B are described below as part of the description of FIGS. 4A and 4B which follows.

FIGS. 4A, 4B, and 4C are block diagrams of the servers 130 of FIG. 2 illustrating how the DC and AC power are supplied to the server electronics 402 through the AC-DC power supplies 132a, 132b according to embodiments of the present disclosure. As shown in FIG. 4A, during normal operation, 100% of the AC power supplied to AC power input of the second AC-DC power supply 132b powers the server electronics 402. No DC power is used to power the server electronics 402.

However, when the AC power supplied to the AC power input of the second AC-DC power supply 132b is insufficient to power the server electronics 402, the DC power supplied to the DC power input of the first AC-DC power supply 132a provides the remaining portion of the power required by the server electronics 402. For example, if the AC power supplied to the first AC-DC power supply 132a can supply only 60% of the power required by the server electronics 402, then the DC power input to the first AC-DC power supply 132a supplies the remaining 40% of the power required by the server electronics 402.

Referring again to FIG. 2, the data pod 210 also includes a charger 212 coupled between the first electrical substation 205a and an energy storage unit 222 for charging the energy storage unit 222 and/or for providing DC power to the first AC-DC power supplies 132a of the servers 130. The controller 223 can connect or disconnect the charger 212 to or from either the energy storage unit 222 or the AC-DC power supplies 132a by operating switches 252 and 254. For example, during a recharging operational mode, the controller 223 can connect the charger 212 to only the energy storage unit 222 by opening or deactivating switch 252 and closing or activating switch 254. During another operational mode, the controller 223 can connect the charger 212 directly to the AC-DC power supplies 132a by activating switch 252 and deactivating switch 254.

The data pod 210 includes two AC inputs: a first AC input 242 that feeds a charger 212 and a second AC input 246 that feeds the servers 130 through the UPS 116. In some embodiments, a first electrical substation (“Substation A”) 205a connects to the first AC input 242 and a second substation (“Substation B”) 205b connects to the second AC input 246.

In other embodiments, the data pod 210 may include only one substation, e.g., Substation A or Substation B, and the UPS 116 and charger 212 are supplied with the same AC source, e.g., Substation A or Substation B. Those skilled in the art will also recognize and understand that in some embodiments, the charger 212 and the inverter 214 may be combined into a single unit (not shown).

In other embodiments, as shown in the data center system 220 of FIG. 3A, the first electrical substation 205a connects to the charger 212 through the first AC input 242 and a switch 356 (e.g., a relay); and a renewable energy source 305 connects to the charger 212 through another AC input 346 and the switch 356. The controller 223 may operate the switch 356 to connect the electrical substation 205a to the charger 212 depending on the ability of the renewable energy source 305 to supply sufficient power to the charger 212.

For example, during normal operation, the controller 223 opens or deactivates the switch 356 to disconnect the electrical substation 205a from the charger 212 so that only the renewable energy source 305 supplies power to the charger 212. Any excess of renewable power from renewable energy source 305 is directed by inverter 214 to the AC grid (not shown) via Substation A (205a). However, if the renewable energy source 305 cannot supply sufficient power to the charger 212, then the controller 223 operates the switch 356 to connect the first electrical substation 205a to the charger 212. The controller 223 may operate the switch 356 so that the electrical substation 205a and the renewable energy source 305 together supply a sufficient amount of power to the charger 212. The data pod 210 also includes an inverter 214 coupled between the electrical substation 205a and the energy storage unit 222 to convert the DC power from the energy storage unit 222 to AC power, which is fed to a first electrical substation 205a (“Substation A”) through an AC output line 244. The inverter 214 includes appropriate transformers, switches (e.g., insulated-gate bipolar transistors (IGBTs)), and other circuitry to generate an AC signal at any desired voltage and frequency. The controller 223 may generate desired voltage and frequency values based on feedback or other control information and transmit the desired voltage and frequency values to the inverter 214.

According to another embodiment of the data pod 210 as shown in FIG. 3A, the inverter 214 is also coupled to the renewable energy source 205 through the charger 212 to convert the power provided by the renewable energy source 205 into an AC power signal appropriate for the first electrical substation 205a. The charger 212 may include a high-power rectifier configured to receive energy from the renewable energy source 305 and to supply that renewable energy to the electrical substation 205a through the inverter 214. Accordingly, the data pod 210 is configured to route energy from the renewable energy source 205 to the electrical substation 205a.

The power distribution system of the data pod 210 also includes a monitor 213 for sensing operational parameters or problems associated with components of the data pod 210, the renewable energy source 203, the electrical substations 205a, 205b, or the power grid. As shown in FIG. 2, the monitor 213 is coupled to sensors 255, 257 placed on the AC power lines coming from the electrical substations 205a, 205b. In another embodiment shown in FIG. 3, the monitor 213 is coupled to a sensor 355 placed on the power lines coming from the renewable energy source 305.

Among other actions, the monitor 213 may detect an overcurrent condition caused by a short circuit or an excessive load in a circuit or system associated with the data pod 210 (or data center system 220). The monitor 213 then transmits this information to the controller 223, which may shut off the inverter 214 or limit the amount of current supplied by the inverter 214. The controller 223 may limit the amount of current supplied by the inverter 214, for example, by controlling the inverter's transistors so as to increase the resistance of the inverter 214 (e.g., by controlling the transistor pulse-width modulation (PWM) switching). The controller 223 may be implemented in a microprocessor or a programmable logic controller.

Alternatively or in addition to controlling the inverter 214, the controller 223 can control the number and/or configuration of batteries in the energy storage unit 222 that connect to the inverter 214 based upon the load requirements of the electrical substation 105a or an associated electrical substation on the same power grid.

The controller 223 also controls the amount of voltage applied to the AC-DC power supplies 132a. For example, the controller 223 may control the energy storage unit 222 so that it supplies about 230 Volts to the AC-DC power supplies 132a. The controller 223 may control the voltage supplied by the energy storage unit 222 by activating the appropriate switches to add or subtract batteries from the batteries in the energy storage unit 222 or place the batteries in a predetermined series/parallel configuration. For example, as described below, the controller 223 can activate appropriate switches to both decrease the voltage of the energy storage unit 222 and maintain a desired level of output current capacity by changing one or more batteries from a series connection to a parallel connection. The switches may be IGBTs, circuit breakers, or other high-power switching elements.

In some embodiments, an external computer system 230 associated with the electrical substation 205a, e.g., a utility company's computer system, communicates over the internet 219 with the controller 223 via a communications interface 217. The external computer system 230 may request that the data pod 210 serve as a power source or as a load in order to control parameters of the power grid. In particular, the external computer system 230 may request that the data pod 210 provide a desired amount of energy to the substation 205a from the renewable energy source 305 and/or the energy storage unit 222. In response, the controller 223 may control the inverter 214 or the energy storage unit 222 to provide all or a portion of the desired amount of energy to the substation 205a.

Alternatively, the external computer system 230 may request that the energy storage unit 222 connect to the electrical substation 205a and thereby serve as a load to receive a desired amount of energy. In response, the controller 223 controls the energy storage unit 222 and/or the charger 212 to receive all or a portion of the desired amount of energy.

The excess energy generated by the renewable energy source 305 can be stored in the data pod's 210 energy storage unit 222 until the power grid needs it. For example, when the renewable energy source 305 generates a peak amount of energy that exceeds the needs of the power grid, the excess energy may be stored in the energy storage unit 222 until it is needed by the power grid (i.e., during peak demand) or by the systems of the data pod 210. The renewable energy source 305 may include one or more of the following sources of power: solar, wind, fuel cell, hydropower, geothermal, or tidal power.

In some embodiments, the energy storage unit 222 includes two or more independent banks of backup batteries in an N+1 configuration to provide redundancy and/or to provide power to the servers 130 over an extended period. For example, the banks of batteries may be configured to provide up to 300 kW of backup power to the servers 130 for about five minutes. In other embodiments, the each independent bank of batteries may service a particular server or server rack.

As shown in FIG. 3A, the energy storage unit 222 may be divided into three independent parts 222a, 222b, and 222c, each of which provides DC power to a different first AC-DC power supply 132a of the servers 130. Each independent part 222a, 222b, and 222c of the energy storage unit 222 may include a battery bank that supplies approximately 320 VDC to a respective first AC-DC power supply 132a.

Referring again to FIG. 2, alternatively, the UPS 116 can also be implemented in an N+1 configuration. Together with an N+1 configuration of the charger 212 and the energy storage unit 222, the UPS 116 provides high reliability in supplying power to the servers 130.

The monitor 213 continually monitors the direction and amount of the electrical current flowing between the data pod 210 and the electrical substations 205a, 205b and the renewable energy source 305. The monitor 213 uses this information to detect faults (e.g., overcurrent) and to determine the net amount of electrical energy received from or provided to the electrical substations 205a, 205b. The net amount of electrical energy is used to calculate the amount of money that should be paid to the utility companies associated with the electrical substations 205a, 205b, the renewable energy source 205, or the owner of the data pod 210.

For example, a utility company associated with electrical substations 205a, 205b may request 100 kWh of energy via the external computer system 230. The controller 223 may then control the energy storage unit 222 or the inverter 214 to supply the requested amount of energy. Thereafter, electrical substation 205a, 205b may supply 10 kWh of energy to the UPS 116 to provide a portion of the energy to power the servers 130. Thus, the monitor 213 will calculate 100 kWh−10 kWh=90 kWh of net energy flowing to a utility company associated with substations 205a, 205b. The owner of the data pod 210 may then send a bill to the utility company requesting payment for 90 kWh of energy.

Typically, the utility companies associated with electrical substations 205a, 205b or the renewable energy source 305 track the net amount of energy flowing to or from the data pod 210, via a calibrated bi-directional “revenue meter” that measures power received from the utility grid by the data pod 210 and measures power delivered to the utility grid from the data pod 210, and provide that information in a bill or other accounting statement to the owner of the data pod 210. The monitor 213, however, may verify that the utility company's energy measurements and calculations are correct.

In some embodiments, the controller 223 may alternately remove power from one of the two AC-DC power supplies 132a, 132b for performing maintenance on the AC-DC power supplies 132a, 132b and associated electronics. Thus, an uninterruptible supply of power to the server may be maintained during maintenance.

Turning now to FIG. 3B, data center system 220′ differs from data center system 220 of FIG. 3A in that instead of three servers 130 each including a first AC-DC power supply 132a and a second AC-DC power supply 132b each supplied power from the three independent parts 222a, 222b and 222c, the three independent parts 222a, 222b, 222c of energy storage unit 222 of data center system 220′ each supplies power individually to servers 130′ via DC-DC power supplies 132a′ that are included in each server 130′. No AC power is provided from VAC feed 224 to the DC-DC power supply 132a′. AC power is provided from VAC Feed 224 only to AC-DC power supplies 132b′ that are included in each server 130′.

It has been shown that, due to the simpler design as compared to the corresponding AC-DC power supplies 132b′, the DC-DC power supplies 132a′ provide about 1% to about 2% higher efficiency.

FIG. 4C is a block diagram of server 130′ of FIG. 3B illustrating the input of DC power to the server electronics 402 through the DC-DC power supplies 132a′ according to embodiments of the present disclosure, wherein at a given exemplary time, 0% of the DC power supplied to server electronics 402 is supplied to server electronics 402 from DC-DC power supply 132a′ while 100% of the DC power supplied to server electronics 402 is supplied to server electronics 402 from AC-DC power supply 132b′. In a similar manner as illustrated in FIG. 4B, the percentage of power supplied by DC-DC power supply 132a′ and AC-DC power supply 132b′ can be varied.

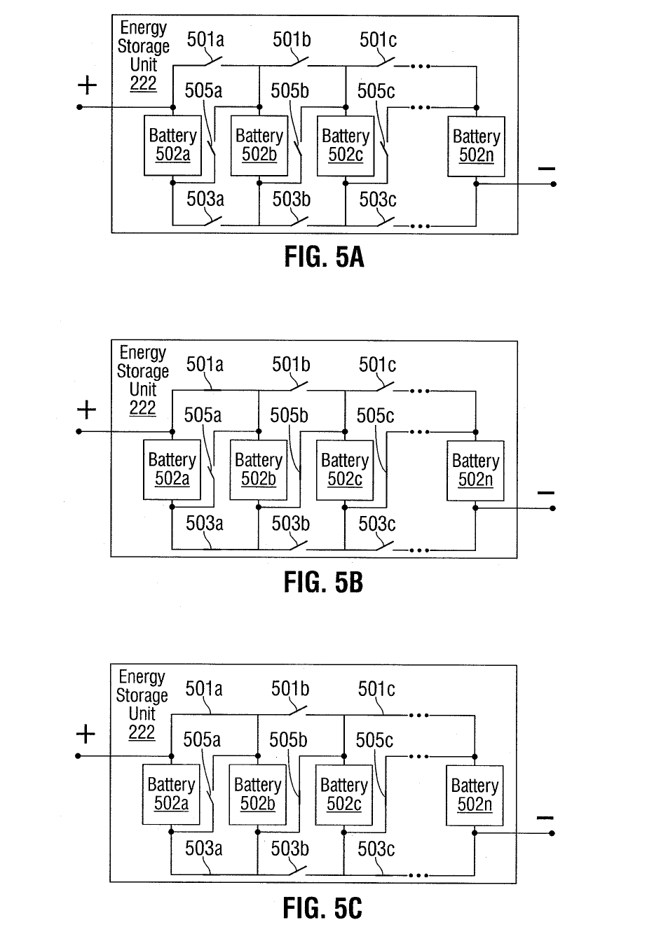

As described above, the energy storage unit 222 may include a plurality of batteries configured to output different total voltage levels by changing how the batteries are electrically connected together. FIGS. 5A-5C are circuit block diagrams of energy storage units 222 having a plurality of switches 501a-501n, 503a-503n, and 505a-505n connected to a plurality of batteries 502a-n in a circuit that allows the controller 223 to change how the batteries are connected together. As shown in FIG. 5A, the switches 501a-501n connect the positive terminals of adjacent batteries 502a-502n, the switches 503a-503n connect the negative terminals of adjacent batteries 502a-502n, and the switches 505a-505n connect the negative terminals of the batteries 502a-502c to the positive terminals of adjacent batteries 502b-502n.

Referring to FIG. 5A, if the controller 223 closes switches 505a-505n, but leaves the other switches 501a-501n, 503a-503n open, then the batteries 502a-502n are in series and the total voltage output by the energy storage unit 222 equals the sum of the voltages of the batteries 502a-502n. If, however, the controller 223 closes switches 501a-501n, 503a-503n, but leaves switches 505a-505n open, then the batteries 502a-502n are in parallel and the total voltage output by the energy storage unit 222 equals the voltage of any one of the batteries 502a-502n assuming that the batteries 502a-502n output the same voltage.

The energy storage unit 222 may output other voltages by connecting the batteries 502a-502n in a combination of series and parallel connections. For example, referring to FIG. 5B, the controller 223 can open and close the switches 501a-501n, 503a-503n, 505a-505n as described above to connect batteries 502a and 502b in parallel and to connect the remaining batteries 502c-502n in series with the batteries 502a and 502b connected in parallel. In this case, the energy storage unit 222 will output a voltage equal to the sum of the voltages of batteries 502b-502n assuming that the batteries 502a and 502b output the same voltage.

In another example shown in FIG. 5C, the switches 501a-501n, 503a-503n, 505a-505n are opened or closed so as to connect batteries 502a and 502b in parallel, to connect batteries 502c and 502n in parallel, and to connect these parallel connections in series. In this case, the energy storage unit 222 will output a voltage equal to the sum of the voltages of batteries 502a and 502c. In this manner, the controller 223 can adjust the voltage output by the energy storage unit 222.

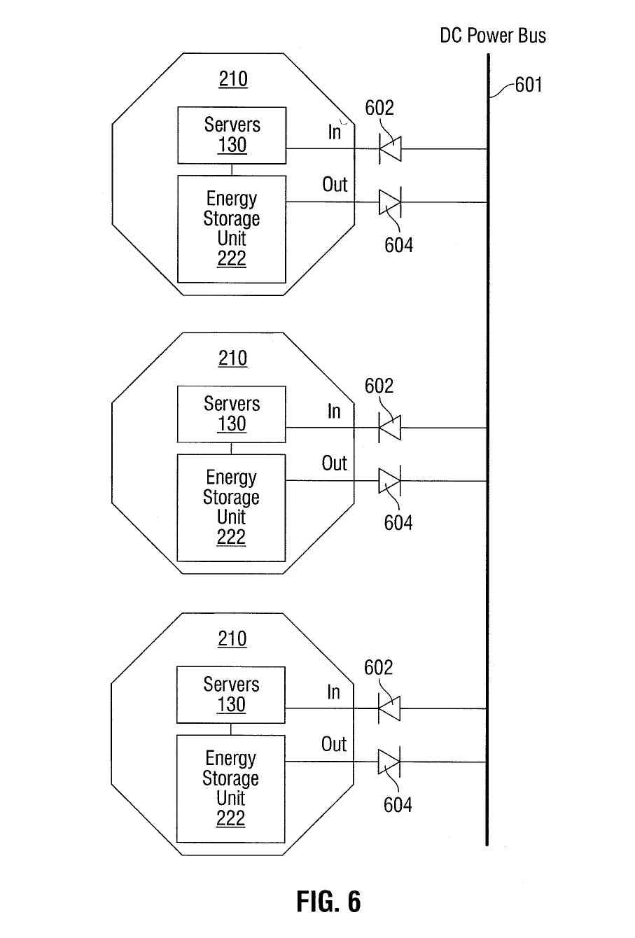

Referring to FIG. 6, in a data center that includes a plurality of data pods 210, the reliability of the power distribution system may be further improved by connecting the energy storage units 222 from different data pods 210 to a common DC power bus 601. As shown in FIG. 6, diodes 602, 604 may be connected between the DC power bus 601 and the input and the output of the data pods 210 to prevent current from flowing into the power output of the data pod 210 and to prevent current from flowing out of the power input of the data pod 210.

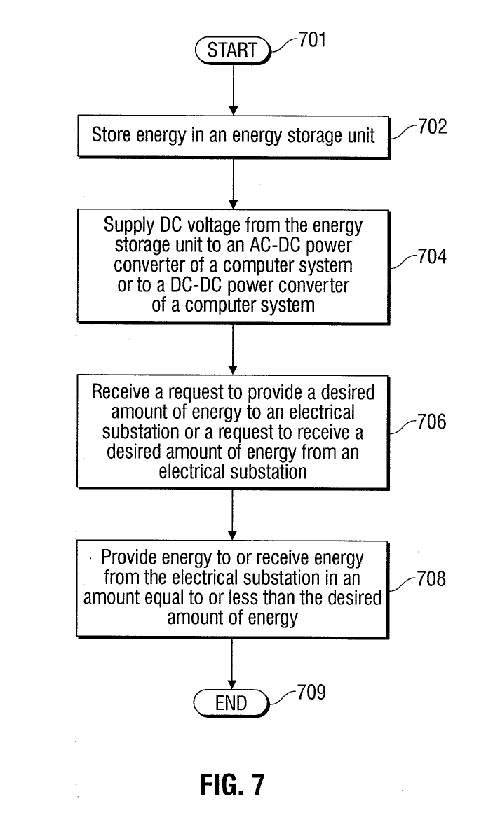

FIG. 7 is a flow diagram of a method for providing an uninterruptible supply of power to the computer system of data pod 210 of FIG. 2 and data center system 220 of FIG. 3A or data center system 220′ of FIG. 3B according to another embodiment of the present disclosure. After starting in step 701, energy from the charger 214 is stored in an energy storage unit, e.g., energy storage unit 222, in step 702. In step 704, DC voltage from the energy storage unit. e.g., energy storage unit 222, is supplied to an AC-DC power converter of the computer system, e.g., AC-DC power supplies 132a and 132b of FIGS. 3A or is supplied to a DC-DC power converter of the computer system, e.g., DC-DC power supplies 132a′ of FIG. 3B . Next, in step 706, the controller 223 receives a request that the data pod 210 provide a desired amount of energy to the electrical substation, e.g., Substation B (205b) of FIG. 2, or a request that the data pod 210 receive a desired amount of energy from the electrical substation, e.g., Substation B (205b) of FIG. 2. Finally, before the process ends in step 709, the controller 223, in step 708, causes the energy storage unit 222 to provide energy to or to receive energy from the electrical substation, e.g., Substation B (205b) of FIG. 2, in an amount equal to or less than the desired amount of energy.

Although the present disclosure has been described with respect to preferred embodiments, it will be readily apparent to those having ordinary skill in the art to which it appertains that changes and modifications may be made thereto without departing from the spirit or scope of the disclosure. For example, the controller 223 may include electronic circuitry and other hardware, rather than, or in combination with, programmable instructions executed by a microprocessor for processing the information sensed by the monitor 213 and determining the control signals to be transmitted to the inverter 214, the energy storage unit 222, the switches 252, 254, and any other controllable functions of the data pod's 210 power distribution system.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of preferred embodiments.

What is claimed is:

1-24. (canceled)

25. A data center system, comprising:
a DC energy storage unit coupled to an external electrical power source; and
at least one computer system including at least a first AC-to-DC power converter directly coupled to the DC energy storage unit and a second AC-to-DC power converter coupled to an external AC power source.

26. The data center system according to claim 1, further comprising an uninterruptible power supply coupled between the external AC power source and the second AC-to-DC power converter.

27. The data center system according to claim 1, further comprising a charger coupled between the external AC power source and the DC energy storage unit, wherein the charger is configured to charge the DC energy storage unit.

28. The data center system according to claim 1, further comprising a controller configured to control electrical energy provided by the DC energy storage unit.

29. The data center system according to claim 1, wherein the DC energy storage unit includes a plurality of batteries and a plurality of switches configured to connect the plurality of batteries in series and/or parallel connections to cause the DC energy storage unit to provide a desired amount of DC voltage.

30. The data center system of claim 5, wherein the plurality of switches are configured to connect at least two batteries of the plurality of batteries in parallel to cause the DC energy storage unit to provide a desired amount of DC voltage that is lower than a maximum DC voltage output of the DC energy storage.

31. The data center system according to claim 1, further comprising an inverter coupled between the external AC power source and the DC energy storage unit and configured to convert DC power from the DC energy storage unit into AC power and provide the AC power to the external AC power source.

32. The data center system according to claim 1, further comprising a power unit coupled between the external AC power source and the DC energy storage unit,
the power unit configured to convert AC power to DC power in a direction from the external power source to the at least one computer system,
the power unit configured to convert DC power to AC power in a direction from the DC energy storage unit to the external electrical power source.

33. The data center system according to claim 1, further comprising a monitor coupled to the external AC power source, the monitor being configured to sense and to calculate net electrical energy flowing to or from the data center system.

34. The data center system according to claim 1, further comprising a renewable energy source coupled to the DC energy storage unit, and wherein the renewable energy source includes one or more of a solar power source, wind power source, hydropower source, fuel cell source, geothermal power source, or tidal power source.

35. The data center system according to claim 1, wherein the DC energy storage unit is configured to supply a sufficiently high DC voltage to the at least one AC-to-DC power converter to decrease heating of portions of the data center system.

36. A data center system, comprising:
a DC energy storage unit coupled to an external electrical power source; and
at least one computer system including at least a DC-to-DC power converter directly coupled to the DC energy storage unit and an AC-to-DC power converter coupled to an external AC power source.

37. A method of providing an uninterruptible supply of power to a computer system, comprising:
storing energy in an energy storage unit;
supplying AC power to a first AC-to-DC power converter of the computer system; and
supplying DC power from the energy storage unit to a second AC-to-DC power converter of the computer system if the AC power is insufficient to power the computer system.

38. The method of claim 13, wherein supplying AC power includes supplying AC power from an uninterruptible power supply.

39. The method of claim 13, further comprising feeding energy from the energy storage unit to an electrical substation via an inverter or charger.

40. The method of claim 13, further comprising:
receiving a request from an external computer system associated with an electrical substation (a) to provide a desired amount of energy from the energy storage unit to the electrical substation or (b) to receive a desired amount of energy from the electrical substation; and
receiving energy from or providing energy to the electrical substation in an amount equal to or less than the desired amount of energy.
